(19) United States
(12) Patent Application Publication
(10) Pub. No.: US 2016/0171859 A1
(43) Pub. Date: Jun. 16, 2016

(54) Safety System for an Enclosed Area

(71) Applicant: Monier Bowlus, Knoxville, TN (US)

(72) Inventor: Monier Bowlus, Knoxville, TN (US)

(21) Appl. No.: 14/570,657

(22) Filed: Dec. 15, 2014

(51) Int. Cl. G08B 21/02; B60R 21/015

(52) U.S. Cl. CPC G08B 21/02; B60R 21/015

(57) ABSTRACT

A safety system for use in monitoring an enclosed area is disclosed. One or more occupancy sensors can be positionable within the enclosed area for detecting the presence of a human or animal within the enclosed area. One or more temperature sensors can be positionable within the enclosed area for monitoring the ambient temperature of the enclosed area. A controller in communication with the occupancy sensor and the temperature sensor can be configured to output a signal when the occupancy sensor indicates that a human or animal is within the enclosed area while the temperature sensor indicates that the ambient temperature of the enclosed area is beyond a threshold.

### BACKGROUND OF THE INVENTION

1. Field of Invention

The present general inventive concept relates to a safety system to alert a user and/or other party to a potentially dangerous thermal condition within an enclosed area, such as for example an automobile.

2. Description of the Related Art

Enclosed areas, and in particular areas enclosed with metal and/or transparent surfaces, such as for example automobiles, freight containers, and the like, are prone to retain thermal energy upon exposure to sunlight or other sources of heat. For example, automobiles of the type having a metal body and a plurality of glass windows enclosing, or substantially enclosing, an interior thereof are known to retain heat within the interior of the automobile when the automobile is exposed to sunlight. In some instances, such heat retention due to sunlight exposure can result in a significant increase in the temperature of the vehicle interior as compared to the temperature of the external atmosphere surrounding the automobile.

In certain circumstances, heat retention in an enclosed area due to sunlight exposure or other factors can result in a dangerous condition within the enclosed area. For example, several instances have occurred in which a child or animal was left for an extended period of time in an enclosed automobile without the ability to exit therefrom, and the automobile was parked in a warm environment, such as in the sunlight on a warm day. In certain of these instances, heat retention due to exposure of the automobile to sunlight caused the interior temperature of the automobile to rise to a dangerously high level, resulting in serious injury, and in some cases death, to the child or animal trapped within the automobile. Other instances have occurred in which a person or animal has become trapped within a freight container or other such enclosure, whereupon similar dangerously high temperatures occurred within the enclosure.

In light of the above, there is a need for a safety system which is suitable to provide a signal in response to a dangerously high temperature condition or a dangerously low temperature condition within an enclosed area, in which an animal or person is located within the enclosed area, such that a user outside the enclosed area may be alerted to come to the aid of the animal or person.

### BRIEF SUMMARY OF THE INVENTION

The present general inventive concept, in various example embodiments, provides a safety system for use in monitoring an enclosed area. In various example embodiments, the safety system may comprise at least one occupancy sensor positionable within the enclosed area for detecting the presence of a human or animal within the enclosed area. At least one temperature sensor may be positionable within the enclosed area for monitoring the ambient temperature of the enclosed area. A controller may be in communication with the occupancy sensor and the temperature sensor. The controller may be configured to output a signal when the occupancy sensor indicates that a human or animal is within the enclosed area while the temperature sensor indicates that the ambient temperature of the enclosed area is above or below a threshold.

The foregoing and/or other aspects and advantages of the present general inventive concept may be achieved by providing a controller that communicates with the occupancy sensor and the temperature sensor via electrical connection. In various embodiments, the controller may communicate with the occupancy sensor and the temperature sensor via wireless communication. In various embodiments, an alarm device may be provided in communication with the controller and configured to emit an alarm when the controller outputs the signal. In various embodiments, the alarm may be an audible alarm or a visual alarm. In various embodiments, the alarm device may be a speaker or may comprise a light source.

In various embodiments, the occupancy sensor may comprise a plurality of occupancy sensors, each occupancy sensor being in communication with the controller. Each occupancy sensor may be selected from the group consisting of a motion sensor, a sound sensor, and a pressure sensor. The plurality of occupancy sensors may comprise at least one pressure sensor, at least one sound sensor, and at least one motion sensor.

The foregoing and/or other aspects and advantages of the present general inventive concept may be achieved by providing a vehicle having an enclosable passenger compartment. The vehicle may comprise at least one occupancy sensor positioned within the passenger compartment for detecting the presence of a human or animal within the passenger compartment. At least one temperature sensor may be positionable within the passenger compartment for monitoring the ambient temperature of the passenger compartment. A controller may be in communication with the occupancy sensor and the temperature sensor. The controller may be configured to output a signal when the occupancy sensor indicates that a human or animal is within the passenger compartment while the temperature sensor indicates that the ambient temperature of the passenger compartment is above or below a threshold.

In various embodiments, the vehicle may further include an alarm device in communication with the controller and configured to emit an alarm when the controller outputs the signal. The vehicle may further include a power switch in electrical communication with the controller and configured to turn the controller on and off. In various embodiments, the power switch may be a two-state switch positioned within the passenger compartment. The power switch may be in communication with an electrical source of the vehicle and an ignition switch of the vehicle. In some embodiments, the power switch is inversely configured in relation to the ignition switch, whereby the power switch is in an “on” state when the ignition switch of the vehicle is in an “off” state and the power switch is in an “off” state when the ignition switch is in an “on” state.

In various embodiments, the occupancy sensor may comprise a plurality of occupancy sensors, each occupancy sensor being in communication with the controller. The plurality of occupancy sensors may comprise a plurality of pressure sensors disposed along a seat surface of the vehicle. In some embodiments, the plurality of occupancy sensors may further comprise at least one motion sensor and at least one sound sensor.

In various embodiments, the controller may configured to output a signal only when all of the occupancy sensors indicate that a human or animal is within the passenger compartment and the temperature sensor indicates that the ambient temperature of the passenger compartment is above or below a threshold.

Additional aspects and advantages of the present general inventive concept will be set forth in part in the description which follows, and, in part, will be obvious from the description, or may be learned by practice of the present general inventive concept.

### BRIEF DESCRIPTION OF THE SEVERAL VIEWS OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a schematic diagram of one embodiment of a safety system for an enclosed area constructed in accordance with several features of the present general inventive concept;

FIG. 2 is a cross-sectional side view of an automobile showing one embodiment of a safety system for an enclosed area constructed in accordance with several features of the present general inventive concept;

FIG. 3 is a schematic diagram of another embodiment of a safety system for an enclosed area constructed in accordance with several features of the present general inventive concept;

FIG. 4 is a top view of an automobile showing another embodiment of a safety system for an enclosed area constructed in accordance with several features of the present general inventive concept;

FIG. 5 is a perspective view of an automobile seat showing another embodiment of a safety system for an enclosed area constructed in accordance with several features of the present general inventive concept;

FIG. 6 is a rear perspective view of the automobile seat of FIG. 5, showing the seat installed in an automobile; and

FIG. 7 is a perspective view of an automobile dash board showing another embodiment of a safety system for an enclosed area constructed in accordance with several features of the present general inventive concept.

### DETAILED DESCRIPTION OF THE INVENTION

Reference will now be made to certain example embodiments of the present general inventive concept, which are illustrated in the accompanying drawings and illustrations. The example embodiments are described herein in order to explain the present general inventive concept by referring to the figures. The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and any sequence type of operations described herein are not limited to that set forth herein and may be changed as is known in the art, with the exception of any operations which would necessarily occur in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is inverted or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various examples of the present general inventive concept, a safety system for an enclosed area is provided which may generate an alert in response to an undesirable high or low temperature conditions within an enclosed area, in which an animal or person is detected within the enclosed area. The safety system for an enclosed area, or “safety system,” includes generally at least one, and in some embodiments multiple, occupancy sensor devices which are positionable within an enclosed area to monitor occupancy of the enclosed area, as well as at least one temperature sensor device to monitor an interior temperature of the enclosed area. These various sensors are capable of communicating with a controller which is configured to generate a signal in response to the detection by the sensors of a combination of conditions which may indicate an elevated temperature within the enclosed area, combined with an occupancy of the enclosed area by a human or animal. In several applications in accordance with the present general inventive concept, the signal may communicated to a user outside the enclosed area, who may respond to the signal and come to the aid of the human or animal within the enclosed area.

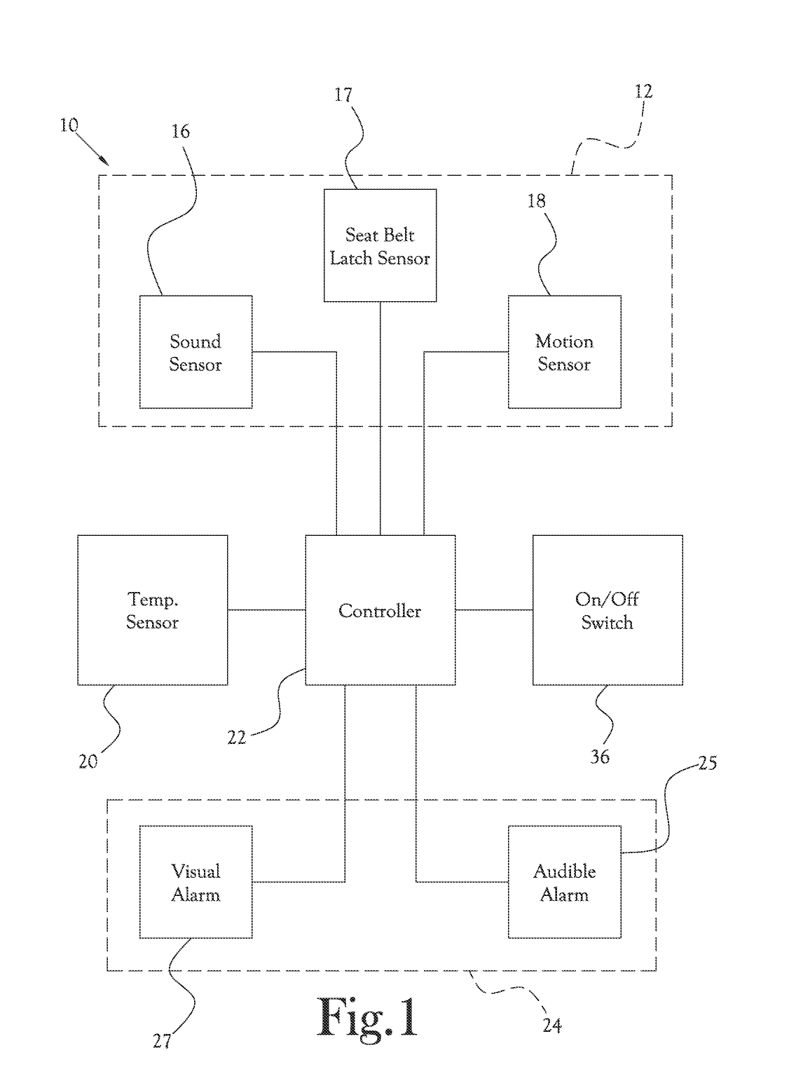

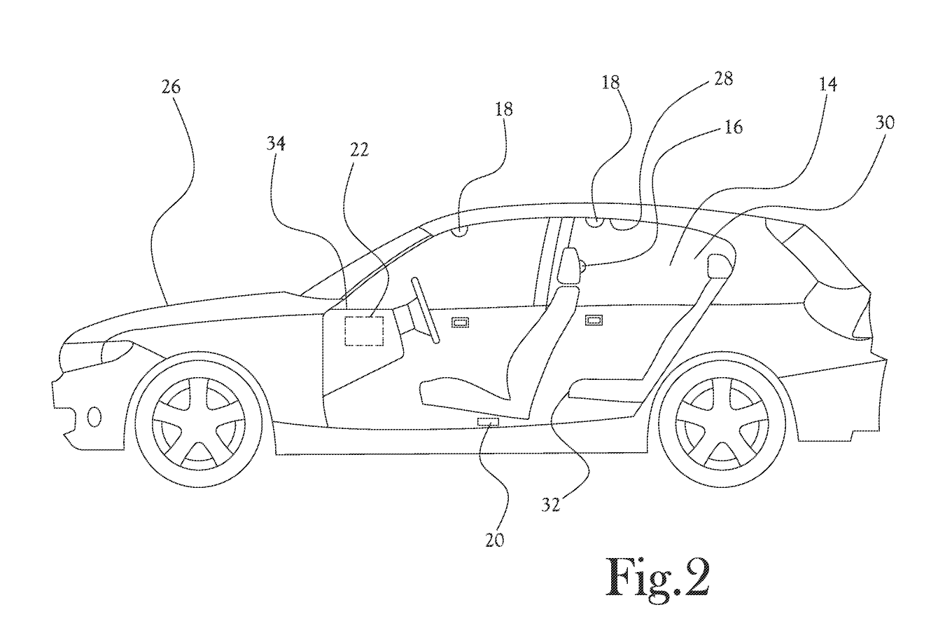

One embodiment of a safety system is illustrated generally at reference numeral 10 in the figures. With reference to FIGS. 1 and 2, the safety system 10 has a plurality of occupancy sensors 12 which are positionable proximate an interior of an enclosed area 14 such that the occupancy sensors 12 may detect one or more occupancy indicators within the interior of the enclosed area 14. It will be recognized that various types of sensor devices are suitable and may be used to accomplish the occupancy sensors 12 without departing from the spirit and scope of the present general inventive concept. For example, in the illustrated embodiment, the enclosed area 14 is an automobile interior, and the occupancy sensors 12 comprise a sound sensor 16, a motion sensor 18, and a seat belt latch sensor 17. The sound sensor 16 is positionable within the enclosed area and is configured to sense one or more sounds of an occupant of the enclosed area 14, such as for example the types of sounds commonly produced by a child or animal. The motion sensor 18 is positionable within the enclosed area and is configured to sense motion of an object, such as a human or animal occupant, within the enclosed area 14. Thus, in the present embodiment, motion and/or sound of an occupant within the enclosed area 14 is detectable by the occupancy sensors 12. Furthermore, the seat belt latch sensor 17 is configured to detect whether a seat belt within the enclosed area 14 is latched. The safety system 10 also has a temperature sensor 20 which is positionable proximate the interior of the enclosed area 14, such that the temperature sensor 20 may detect and monitor the ambient temperature of the interior of the enclosed area 14.

A controller 22 is provided in communication with the various occupancy sensors 12 and the temperature sensor 20, such that the controller 22 may receive indications from each of the various sensors 12, 20 regarding the above-discussed monitored conditions of the interior of the enclosed area 14. The controller 22 is configured to produce a signal in response to a combination of sensory data received from the sensors 12 which would indicate the occupancy of the enclosed area 14 by a human or animal, together with an ambient temperature within the enclosed area 14 above or below a threshold temperature. For example, the controller 22 can be configured to produce an output signal to an external device in response to either the sound sensor 16 or the motion sensor 18 detecting occupancy of the enclosed area 14, when such detection of occupancy coincides with an indication by the temperature sensor 20 that the ambient temperature within the enclosed area 14 is above or below a particular threshold temperature. The controller 22 is configured to produce an output signal in response to both the sound sensor 16 and the motion sensor 18 detecting occupancy of the enclosed area 14, together with an indication by the temperature sensor 20 that the ambient temperature within the enclosed area 14 is above or below a particular threshold temperature. Thus, the sound sensor 16 and motion sensor 18 can provide redundancy in the detection of occupancy within the enclosed area 14, thereby reducing the likelihood that a signal may be produced by the controller 22 absent actual occupation of the enclosed area 14 by a human or animal.

In various embodiments of the present general concept, the external device can be an alarm 24 to alert a user exterior of the enclosed area 14 that the enclosed area 14 is likely to be occupied by a human or animal and that the ambient temperature within the enclosed area 14 is above or below the threshold value. For example, in the illustrated embodiment, an audible alarm device 25 and a visual alarm device 27 can be provided in communication with the controller 22 and are configured to emit audible and visual alarms, respectively, when the controller 22 produces an output signal in response to an indication of occupancy of the enclosed area 14 combined with an ambient temperature within the enclosed area 14 beyond (i.e., above or below) the threshold value. In various embodiments, the alarm 24 may comprise an electronic sound speaker, bell, siren, or the like. In other embodiments, the external device can be a visual indicator, such as a light or other signaling device, in communication with the controller 22 to provide a visual signal in response to the output signal of the controller 22. Various other external devices, such as cell phones, pagers, smart phones, tablets, email, 911 devices, emergency signal generators, or other known or later developed devices can be used.

It is noted that the simplified diagrams and drawings included in the present application do not illustrate all the various connections and assemblies of the various components described herein. However, those skilled in the art will understand how to implement such connections and assemblies, using sound engineering judgment, based on the illustrated components, figures, and descriptions provided herein. For example, in several embodiments, each of the occupancy sensors 12 and the temperature sensor 20 is electrically connected to the controller 22 via suitable electrical wires, plugs, etc., and likewise, the controller 22 is electrically connected to the alarm 24 via electrical wiring and connectors of the type known in the art. In other embodiments, at least one, and in some embodiments each, of the occupancy and temperature sensors 12, 20 communicates with the controller 22 via a wireless connection. Moreover, in some embodiments, the controller 22 communicates with the alarm 24 via a wireless connection.

In several embodiments, the alarm 24 may be accomplished via communication of the controller 22 with a an external device such as a personal computing device, such as for example a cellular telephone, mobile computer, personal computer, pager, vehicle communications module, or the like. For example, in one embodiment, the controller 22 is configured to transmit an output signal wirelessly to one or more personal computing devices in response to an indication of occupancy of the enclosed area 14 combined with an ambient temperature within the enclosed area 14 beyond a threshold temperature. The personal computing device is, in turn, configured to provide a notification, such as an electronic mail message, text message, chime, or the like, to a user of the device in response to the output signal of the controller 22. Thus, a user of the personal computing device is alerted to the potential presence of a human or animal within the enclosed area 14 being subjected to a potentially unacceptably high, or a potentially unacceptably low, ambient temperature. In another embodiment, in which the safety system 10 is installed within a motor vehicle, the controller 22 is in electrical communication with a vehicle telecommunication and remote operation module, of the type employed and serviced by General Motors Corporation and its subsidiaries under the service mark “OnStar®.” In this embodiment, upon receipt by the module of an output signal from the controller 22 indicating occupancy of the vehicle combined with an ambient temperature within the vehicle beyond the threshold temperature, the module may provide a notification to a third party, whereupon the third party may take a responsive action, such as for example notification of the vehicle owner, notification of a third party of the location, ownership information, and status of the vehicle, and/or actuation of remote vehicle controls, for example to unlock or open a door or window of the vehicle, to activate an air conditioning or heating system within the vehicle, etc. In yet another embodiment, the temperature sensor 20 may be deactivated and the controller 22 configured to produce an output signal indicating occupancy of the vehicle while the vehicle engine is off, thereby indicating, for example, the potential that a passenger of the vehicle has been inadvertently left in the vehicle after the vehicle was parked.

FIG. 2 is a cross-sectional side view of an automobile 26, showing a schematic representation of the safety system 10 installed within the automobile's interior. In the illustrated embodiment, motion sensors 18 are each installed along an interior surface of the roof 28 of the automobile 26, above each of the seats of the vehicle's interior. A sound sensor 16 is installed behind a front seat of the vehicle, facing a rear portion 30 of the vehicle's interior. A temperature sensor 20 is installed beneath the front seat of the vehicle's interior. In the illustrated embodiment, the temperature sensor 20 is an omnidirectional sensor, while the sound sensor 16 and motion sensor 18 are each directional sensors and are oriented to face generally downward toward a seat 32 of the automobile 26. Thus, the sound and motion sensors 16, 18 are configured to sense sound and motion, respectively, occurring proximate the seats 32 of the automobile 26. In this configuration, the safety system 10 may be used, for example, to alert a user of the automobile 26 in the event a child is seated in the rear seat 32 of the automobile 26 during a time when the ambient temperature within the automobile is unacceptably high or low. However, it will further be understood that each of the various sensors 16, 18, 20 may be unidirectional, multi-directional, or omnidirectional in their design without departing from the present general inventive concept.

In various embodiments, such as the embodiment of FIGS. 1 and 2, the controller 22 may be positioned in any of numerous locations inside or outside the enclosed area 14. For example, in the embodiment of FIG. 2, the controller 22 is disposed along the dash board 34 of the automobile 26, forward of the interior portion of the automobile forming the enclosed area 14. In other embodiments, the controller 22 may be positioned at a location within the enclosed area 14. For example, in some embodiments, the controller 22 may be positioned adjacent, or integrated with, one or more of the various sensors 16, 18, 20, such that the controller 22 and sensors 16, 18, 20 comprise a single unitary device.

In several embodiments, the controller 22 is electrically connected to a power switch 36, which may be used to turn the safety system 10 on and off. In several embodiments, the power switch 36 comprises a two-state switch of the type known in the art which may be directly actuated by a user of the safety system 10. In other embodiments, the power switch 36 may be connected to, and may depend from, one or more other devices, such that the controller 22 is automatically switched on and off by the other device. For example, in the embodiment of FIG. 2, the power switch 36 is electrically connected to an onboard electrical power source of the automobile 26, such as the automobile's battery, and is further electrically connected to the ignition switch of the automobile 26. The “on” and “off” states of the power switch 36 are configured inversely to the “on” and “off” states of the ignition switch of the automobile 26. Thus, when the ignition of the automobile 26 is turned off, the safety system 10 is turned on, and conversely, when the ignition of the automobile 26 is turned on, the safety system 10 is turned off. In other embodiments, the power switch 36 is configured to allow scanning of the vehicle interior while the ignition switch of the automobile 26 is turned on. In other embodiments, the power switch 36 may be controlled by one or more of the various sensors, such as for example the motion sensor 18. Thus, upon detection of motion within the enclosed area 14 by the motion sensor 18, the safety system 10 may be turned on, whereupon the controller 22 may receive information from the sensors. In still other embodiments, the power switch 36 may be built into the controller 22, such that if the safety system 10 senses motion or sound within the vehicle interior, the system 10 can activate automatically for a period of time. In still other embodiments, the power switch 36 may be configured for remote operation via a smart device, personal computer, or the like. In other embodiments, the power switch 36 may be a three-state power switch, of the type having an “on,” “off,” and “standby” setting.

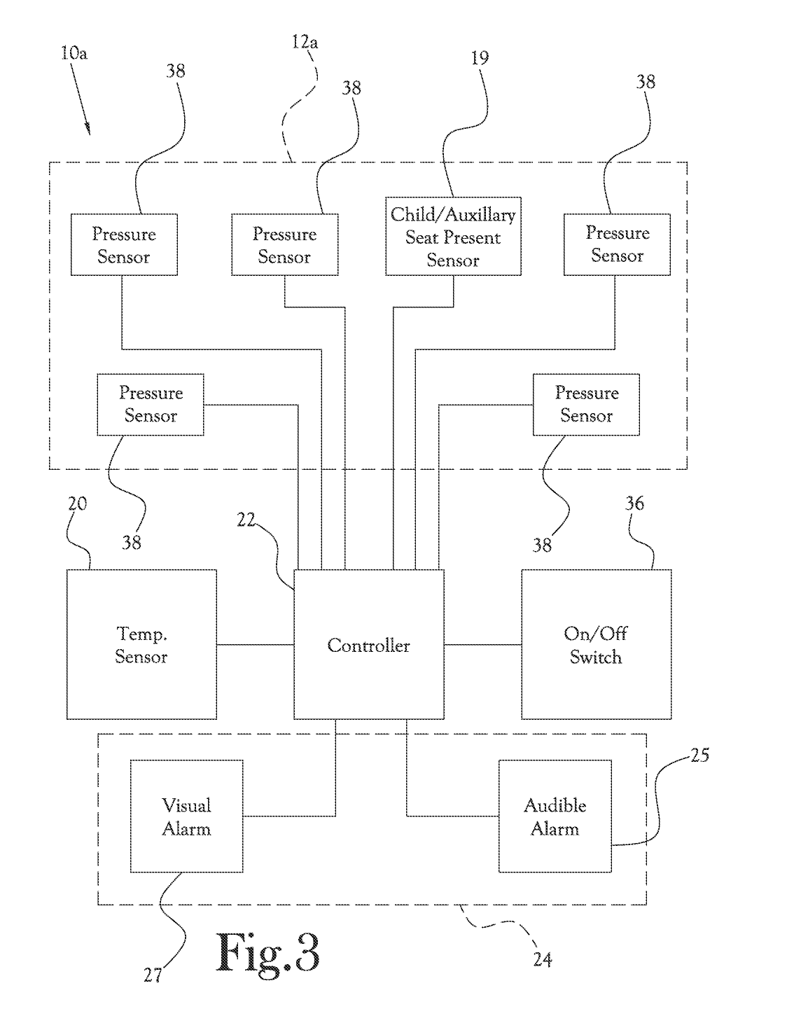

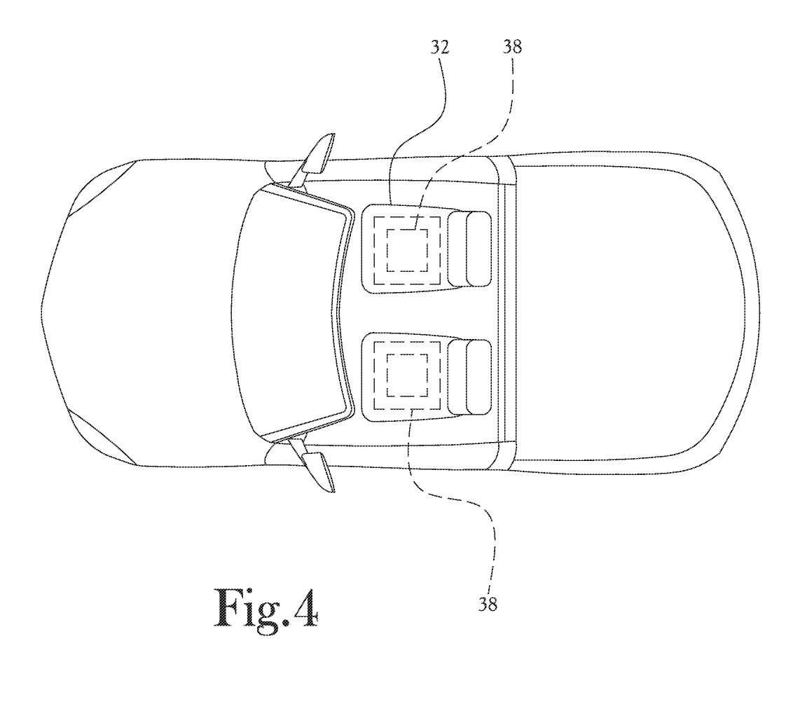

FIGS. 3 and 4 illustrate another embodiment of a safety system 10a constructed in accordance with several features of the present general inventive concept. In the embodiment of FIGS. 3 and 4, the occupancy sensors 12a are comprised of a plurality of pressure sensors 38, each of which is in communication with the controller 22. As shown in FIG. 4, each of the pressure sensors 38 is disposed along a different seat surface of the seats 32 of an automobile 26. The controller 22 is configured to produce a signal in response to a combination of sensory data received from the various pressure sensors 38 which would indicate the occupancy of one or more of the seats 32 in the automobile 26, together with an indication from the temperature sensor 20 that the ambient temperature within the enclosed area 14 is below a threshold temperature. For example, in one embodiment, the controller 22 is configured to produce an output signal in response to the above-discussed low temperature within the enclosed area 14 in combination with sensory data indicating that a heavy weight, such as a small child, an animal, or a child's car seat is positioned on the seat 32 of the automobile 26. In another embodiment, the controller 22 is configured to produce an output signal in response to the above-discussed low temperature within the enclosed area 14 in combination with sensory data indicating a change in pressure applied to a seat surface of the automobile 26. Thus, in this embodiment, the pressure sensors 38 may serve to detect movement of a heavy object, such as for example a child or animal, onto or off of a seat surface of the automobile 26.

It will be recognized that numerous devices exist which are suitable for use in accomplishing the occupancy sensors 12 in accordance with the present general inventive concept. For example, in various embodiments, the above-discussed pressure sensors 38 may be any of various types of pressure sensors, including, but not limited to, capacitive or elastomer pressure sensors. Additionally, it will be recognized that other types of sensors can be incorporated into the safety system 10 without departing from the spirit and scope of the present general inventive concept. For example, in some embodiments, the occupancy sensors 12 of the safety system include at least one sensor to detect whether a seatbelt in an automobile is fastened, wherein a fastened seatbelt is indicative of occupancy of that seat of the automobile. In other embodiments, the occupancy sensors 12 may include at least one camera or video sensor, and in more discreet embodiments, such cameras or video sensors may operate using facial recognition and/or facial tracking features of the type known to one of skill in the art for recognizing facial characteristics in order to identify a human or other animal within the enclosed area. In still other embodiments, the occupancy sensors 12 may include one or more switches, buttons, or other suitable controls which may be actuated by an occupant, for example a panic switch, configured to send a panic or emergency signal to one or more external devices.

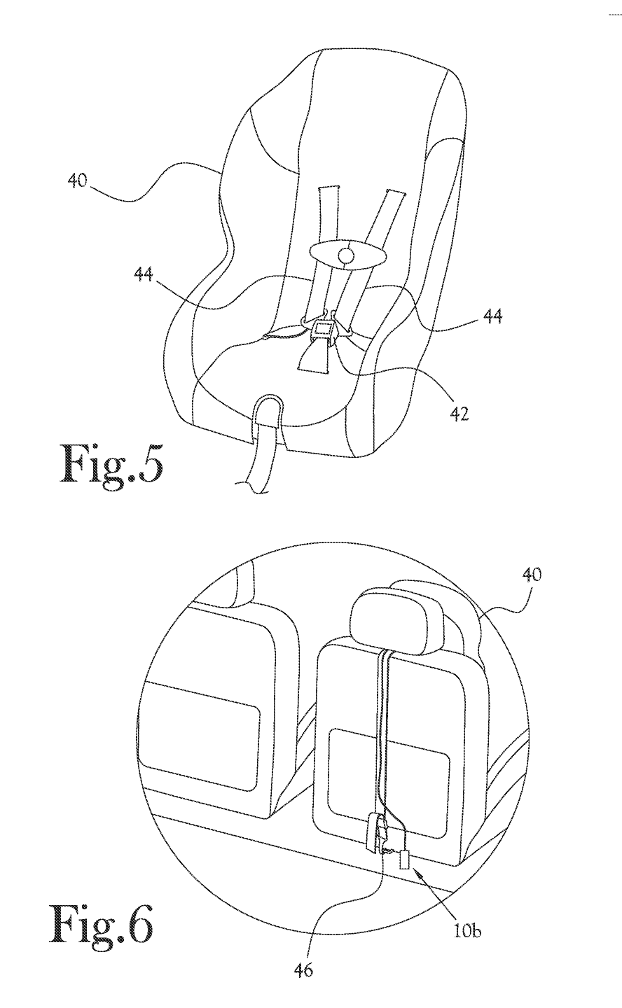

FIGS. 5 and 6 illustrate another embodiment constructed in accordance with several features of the present general inventive concept. In this embodiment, the safety system 10b is incorporated into a car seat 40, of the type commonly used to restrain a child within an automobile. The car seat 40 includes generally a seat belt buckle 42, for securing one or more seat belts 44 of the car seat 40 about an occupant, and at least one latch 46 for securing the car seat 40 to a seat of an automobile. In this embodiment, the safety system 10b includes a controller which is in operative communication with the latch 46 and the buckle 42. The controller is configured to produce a signal in response to an indication from the temperature sensor 20 that the ambient temperature within the automobile is above a threshold temperature, together with a combination of sensory data received from the latch 46 and the buckle 42 that would indicate that both the latch 46 and the buckle 42 are fastened, thereby indicating occupancy of the car seat 40 together with installation of the car seat 40 to a seat in an automobile.

As noted above, in several embodiments, the safety system 10 may be configured for use in an automobile or other motor vehicle. In several embodiments, the safety system 10 is assembled into a unitary device or an aftermarket kit which may be installed, mounted, and/or located at any of numerous locations within a vehicle for use therein. For example, in various embodiments, the safety system 10 may be mounted for use within a passenger compartment of an automobile, within a vehicle trunk, in a truck bed area of a truck, within a trailer portion of a vehicle such as a camping trailer or cargo trailer, or within an engine compartment of the vehicle, for example, to detect the presence of rodents or other animals within the engine compartment. In other embodiments, the safety system 10 may be incorporated into one or more existing fixtures of the vehicle or accompanying devices. For example, in various embodiments, the various components of the safety system 10 may be incorporated into one or more of a dome light, rear view mirror, internal video camera, headliner, frame, seat, dashboard, speaker or speaker grill, radio, etc., of a vehicle. In other embodiments, the various components of the safety system 10 may be incorporated into a child car seat or other such device.

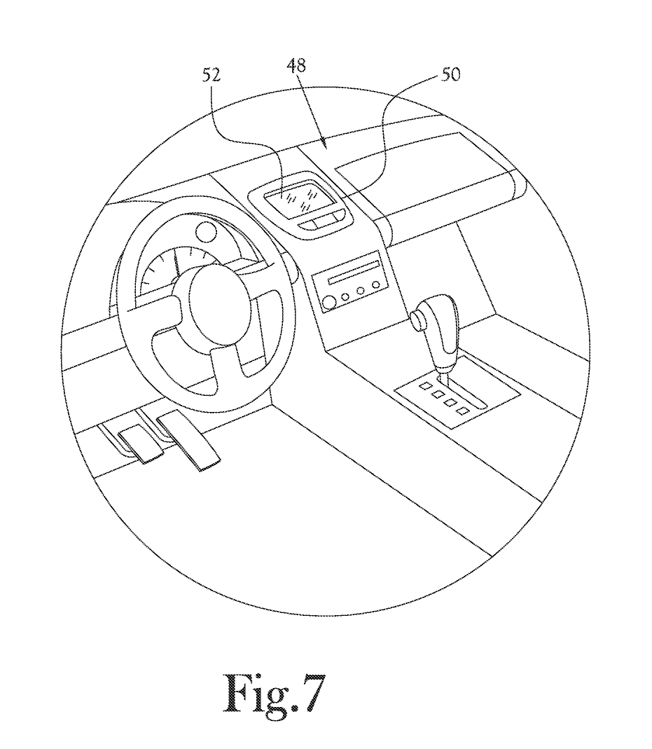

FIG. 7 illustrates one embodiment of a vehicle dash board 48 incorporating components of the safety system 10. In the illustrated embodiment, the above-discussed controller is in operative communication with a user interface 50 incorporated into the dash board 48 of the automobile. In this embodiment, the user interface 50 includes at least one touch-screen display 52 which provides suitable controls for operation and/or configuration of the safety system 10 by a user. For example, in one embodiment, the touch-screen display 52 provides controls for turning the safety system 10 on and off, and for setting the threshold temperature beyond which the controller 22 will issue a signal to the alarm 24. In certain more discreet embodiments, the user interface 50 may communicate with the safety system 10 via wireless connection, and may further communicate with a cellular or other wireless communication device is further discussed below.

It will further be recognized that the safety system 10 may be employed for use in other applications to monitor conditions within an enclosed area and to provide an alert in the event the ambient temperature of the enclosed area rises or falls while the enclosed area is occupied. For example, in several embodiments, the safety system 10 may be employed within a room of a building, such as for example a residence, one or more rooms of a hospital or convalescent facility, office, warehouse, or the like, to monitor conditions within the room and to provide an alert in the event the ambient temperature of the room rises while the room is occupied. In some embodiments, the safety system 10 may be configured in communication with a security system, building alarm, or other such device, such that the device produces an alarm or other signal in response In other embodiments, the safety system 10 may be employed within a habitable enclosed container, such as for example a shipping container, railroad car, semi-trailer, or the like. In these embodiments, the safety system 10 may be used, for example, to monitor a potentially undesirable condition within the enclosed container resulting from undesirable increase in temperature within the container. The safety system 10 may also be used to detect whether the container has been opened and/or tampered with. For example, in several embodiments, the safety system 10 may be incorporated into a door alarm or other such device, and may further be placed in communication with a telecommunications device, such that the safety system 10 provides an alert to a police or border patrol agency, or similar third party, in response to an indication that the container contains humans or animals and that the ambient temperature within the container is at an undesirable level.

As described hereinabove, a device constructed in accordance with the present general inventive concept is intended to prevent the unintended and/or accidental death or injury of living beings by warning the owner and or driver of a vehicle or attendant of a room such as in a home or assisted living building that motion and/or internal sound is detected within an area during undesirable conditions, such as extreme temperatures beyond the limits that a living being is able to survive, or conditions that are undesirable to be in. In a vehicle, the safety system 10 can use seat pressure switches to determine if the seat is occupied, and also it can detect when a child seat is mounted in a seat with specifically designed car seat belt connections. A sensor, sensor array and/or single or multiple sensors that detect temperature, and/or motion, and/or sound to detect if a living being is in an undesirable environmental living situation may be provided. The area can be specific, such as an enclosed automobile, trailer or a living area or other area within a home or building, but need not be limited to these types of areas. Connections can be wired or wireless. The sensor system can be part of an existing fixture such as a dome light in a vehicle, rear view mirror and/or internal video camera, headliner, frame, seat, dashboard, speaker or speaker grill, radio, car child seat, etc.

In an automotive setting, a single, and/or multiple sensors or series of sensors that sense temperature, sound, and motion may be provided. The safety system 10 can use single, multi, omnidirectional, or any other type of appropriate sensors. The sensor array may search the internal areas of the vehicle or area to detect movement at the moment the ignition is started. The system may detect motion, for example, of a child in a car seat. This information may be recorded and can be stored in an internal memory of the safety system 10. Once the vehicle is stopped and the ignition is turned off, the driver may exit the vehicle and lock the car either via a remote keyless entry/lock device or by pressing the lock button on the door before exiting the vehicle. This may trigger a reminder audible tone that motion was detected, and that a human or animal is now locked in the vehicle. Notification can be by means of the vehicle horn or some other visual or audible device that emits a visual indication and/or audible sound specifically intended to gain the attention of the driver that motion was sensed in the vehicle and that the doors in that area were locked and not opened after the ignition was turned off. The safety system 10 may then go into a monitoring mode detecting motion, temperature and/or sounds within the vehicle. If an undesirable environment is detected, a series of notifications can be provided. The safety system 10 may be designed to notify the owner, family members, other authorized persons, monitoring services and/or passers-by before dangerous conditions exist. It will be recognized that the purpose of this is to prevent the purposely and/or accidental death to living breathing life forms.

Notifications of the detection of sound and/or motion in combination with undesirably high temperature within the enclosed area can be made through any of a number of methods. For example, such notification can be by means of a smart device application (hereinafter “APP”) program. More specifically, the safety system 10 can reach-out to the owners or authorized persons via a smart device by using open and/or closed wireless, wired, cellular and/or other networks and notify the owner through visual and/or audible means. The APP can display a pop-up window notification on a single or multiple installed device(s). The notification can be by means of a personal computer, tablet, or cellular device. For example, the safety system 10 can reach-out to the owners or authorized persons through open and/or closed wireless, wired and/or cellular networks and notify the owner through visual and/or audible means. The personal computer program, for example, can display a pop-up window notification on the installed device, and/or display a sound or proprietary audio sound. The notification can be by means of a proprietary, common, open network to notify everyone on said network including nearby Bluetooth™ enabled devices and/or Wi-Fi networks, but need not be limited to these types of networks. The notification can be by means of a phone call, and/or page, and/or text message, and/or email, and/or other type of communication which has identified unrelated, authorized persons via phone call or text with the location and/or description of the incident and any other pertinent information necessary to find the location of the event. The notification can be by a monitoring service which receives a notification allowing them to send messages through their communications systems, and/or an APP, and/or a text message, and/or page, and/or a phone call and/or voicemail, and/or an email to people in the immediate area to check the car. The notification can connect to existing proprietary vehicle monitoring services, such as the type employed and serviced by General Motors Corporation and its subsidiaries under the service mark “OnStar®,” or similar services, to alert the service to a concern. A monitoring service, owner or authorized person can have the option to use an optional internal camera to visually inspect the vehicle remotely and/or reset the warning remotely. The notification can be by provision of GPS location or address of the event. Owner information, such as phone number, vehicle make, model, year, etc. can be provided, for example by sending the data to the monitoring service or other location. The safety system 10 can notify police or 911 operators. The notification can be by means of flashing external lights in an “SOS” or other universal pattern.

If the notifications go unanswered or an event is, or becomes, critical, the safety system 10 may trigger lights flashing and/or an audible sound such as a horn or other audible sound to catch the attention of persons nearby. In some embodiments, this may include flashing and/or sounding in an “SOS” pattern. The notification can be by means of a proprietary audible sound, by means of an audible tone, or a visual event specifically designed for this purpose. The safety system 10 can connect to a vehicle's systems to control specific functions such as, starting the vehicle to run the air conditioner or heating system, to lower the windows in vehicles without air conditioning. In some embodiments, a special and/or unique “Key code”, sound or light/LED pulse can be provided to the authorities to unlock a vehicle during the alarm active cycle to eliminate the need to break windows or otherwise damage the vehicle. The special key can be a remote control/FOB type device or an APP on an authorized smart device which will unlock the active vehicle. The safety system 10 may record and send smart device information to a verification center to verify authorization prior to unlocking. The unlocking signal can be a specific audible tone and/or tone pulse for a specific duration, which could be combined with a light pulse and/or strength which is emitted from a device and/or smart device provided to authorities or the owner (in case they are locked out). The sound may emit from a device or smart device such that, when placed near the vehicle in a specific location, the audible pulse and/or tone which may also have a light pulse is recognized by the vehicle and the door(s) are subsequently unlocked. Alternatively, the light signal can be a light-emitting diode (“LED”) pulse that is emitted from the device or smart devices, such as a camera flash LED, in a manner that, when placed in a specific position near the vehicle, unlocks the vehicle.

The safety system 10 may include sensors that detect if a child's car seat is installed. A seat belt “locked” detector can be integrated in to the safety system 10. The notification can be by the same means that a car detects whether seat belts are engaged or not. When the seat belt is detected as being secured, the safety system 10 may interpret that detection as corresponding with occupation of the enclosed area 14. The notification can be by means of detecting the presence of a child seat. In some embodiments, a child's car seat which is installed in the vehicle may be detected through the vehicle's seat belt system, detecting whether or not the seat belt is fastened, or a proprietary sensor system. The notification can be by means that the vehicle detects that there is a child seat present. In some embodiments, sensors can be mounted in child car seats to detect pressure, and/or movement and/or if the child seat belt is secured. Car seats may be specifically designed with sensors built in to detect if the seat belt is secured or otherwise latched.

From the foregoing description, it will be recognized that several embodiments of a safety system for an enclosed area are described and provided herein. The safety system may be used to generate an alert in response to an undesirable high or low temperature condition within an enclosed area, in which an animal or person is also detected within the enclosed area. While the present invention has been illustrated by description of several embodiments and while the illustrative embodiments have been described in detail, it is not the intention of the applicant to restrict or in any way limit the scope of the appended claims to such detail. Numerous variations, modifications, and additional embodiments are possible, and accordingly, all such variations, modifications, and embodiments are to be regarded as being within the spirit and scope of the present general inventive concept.

What is claimed is:

1. A safety system for use in monitoring an enclosed area, the safety system comprising:
at least one occupancy sensor positionable within the enclosed area for detecting the presence of a human or animal within the enclosed area;
a controller in communication with the occupancy sensor, the controller configured to output a signal to an external device when the occupancy sensor indicates that a human or animal is within the enclosed area.

2. The safety system of claim 1 further comprising at least one temperature sensor positionable within the enclosed area for monitoring the ambient temperature of the enclosed area, wherein the controller is configured to output a signal when the occupancy sensor indicates that a human or animal is within the enclosed area while the temperature sensor indicates that the ambient temperature of the enclosed area is beyond a threshold.

3. The safety system of claim 2, the controller communicating with the occupancy sensor and the temperature sensor via electrical connection.

4. The safety system of claim 3, the controller communicating with the occupancy sensor and the temperature sensor via wireless communication.

5. The safety system of claim 4, the controller being in communication with a smart device.

6. The safety system of claim 2 further including an alarm device in communication with the controller and configured to emit an alarm when the controller outputs the signal.

7. The safety system of claim 6, the alarm being an audible alarm.

8. The safety system of claim 7, the alarm device being selected from the group consisting of a speaker and a horn.

9. The safety system of claim 6, the alarm being a visual alarm.

10. The safety system of claim 6, the alarm being selected from the group consisting of an electronic page, a text message, an e-mail, a telephone call, a notification to a vehicle telecommunication module, a notification to a vehicle remote operation module, a notification to a personal computing device, and a notification to a cellular communication device.

11. The safety system of claim 9, the alarm device comprising a light source.

12. The safety system of claim 2, further comprising a panic switch configured to be actuated by an occupant of the enclosed area, the controller being configured to output the signal in response to actuation of the panic switch.

13. The safety system of claim 2, the occupancy sensor being a plurality of occupancy sensors, each occupancy sensor being in communication with the controller.

14. The safety system of claim 13, each occupancy sensor being selected from the group consisting of a motion sensor, a sound sensor, a pressure sensor, and a camera.

15. The safety system of claim 14, the plurality of occupancy sensors comprising at least one camera configured to detect motion and to perform facial recognition of occupants within the enclosed area.

16. The safety system of claim 13, the plurality of occupancy sensors comprising at least one pressure sensor, at least one sound sensor, and at least one motion sensor.

17. A child vehicle seat for use with a safety system according to claim 1, the occupancy sensor being carried by the child vehicle seat.

18. The child vehicle seat of claim 17, the occupancy sensor being configured to detect occupancy of the child vehicle seat.

19. The child vehicle seat of claim 18, the occupancy sensor being configured to detect a fastened condition of a seat belt of the child vehicle seat.

20. A vehicle having an enclosable passenger compartment, the vehicle comprising:
at least one occupancy sensor positioned within the passenger compartment for detecting the presence of a human or animal within the passenger compartment;
at least one temperature sensor positionable within the passenger compartment for monitoring the ambient temperature of the passenger compartment; and
a controller in communication with the occupancy sensor and the temperature sensor, the controller configured to output a signal when the occupancy sensor indicates that a human or animal is within the passenger compartment while the temperature sensor indicates that the ambient temperature of the passenger compartment is above or below a threshold.

21. The vehicle of claim 20 further including an alarm device in communication with the controller and configured to emit an alarm when the controller outputs the signal.

22. The vehicle of claim 21 further including a power switch in electrical communication with the controller and configured to turn the controller on and off.

23. The vehicle of claim 22, the power switch being a three-state switch positioned within the passenger compartment, the three-state switch having “on,” “off,” and “standby” states.

24. The vehicle of claim 23, the power switch being in communication with an electrical source of the vehicle and an ignition switch of the vehicle.

25. The vehicle of claim 24, wherein the power switch is inversely configured in relation to the ignition switch, whereby the power switch is in either an “on” state or a “standby” state when the ignition switch of the vehicle is in an “off” state and the power switch is in an “off” state when the ignition switch is in an “on” state.

26. The vehicle of claim 22, said power switch being configured to turn the controller on when the occupancy sensor indicates that a human or animal is within the passenger compartment.

27. The vehicle of claim 20, the controller being integral with an internal computer of the vehicle.

28. The vehicle of claim 20, the occupancy sensor being a plurality of occupancy sensors, each occupancy sensor being in communication with the controller, the plurality of occupancy sensors comprising a plurality of pressure sensors disposed along a seat surface of the vehicle.

29. The vehicle of claim 28, the plurality of occupancy sensors further comprising at least one motion sensor and at least one sound sensor.

30. The vehicle of claim 29, the controller being configured to output a signal only when all of the occupancy sensors indicate that a human or animal is within the passenger compartment and the temperature sensor indicates that the ambient temperature of the passenger compartment is above or below a threshold.

31. The vehicle of claim 30, the output signal being configured to activate a device of the vehicle, the device being selected from the group consisting of an air conditioner, a heater, a window, or a door lock.
